(19) United States
(12) Patent Application Publication
(10) Pub. No.: US 2003/0033434 A1
(43) Pub. Date: Feb. 13, 2003

(54) Client aware content scrapping and aggregation in a wireless portal system

(76) Inventors: Sathya Kavacheri, Sunnyvale, CA (US); Thomas Mueller, Fremont, NE (US); Luu Tran, Santa Clara, CA (US)

Correspondence Address: WAGNER, MURABITO & HAO LLP, Two North Market Street, Third Floor, San Jose, CA, 95113, US

(21) Appl. No.: 09/929,545

(22) Filed: Aug. 13, 2001

(51) Int. Cl. G06F 15/16

(52) U.S. Cl. 709/246; 709/219

(57) ABSTRACT

A wireless portal system has a wireless server with a client aware content scrapping and aggregation method and system. The client aware content scrapping and aggregation system includes logic for identifying client wireless devices connecting to the wireless by using particular characteristics of the client in presenting content selected in response to connection requests from the client to the server. In one embodiment of the invention, the client aware content scrapping system receives an indication of a client type and uses this information to automatically search for content from a variety of web-sites on the Internet and formats content selected by the end-user for delivery to the client. The scrapping logic further allows content gathered from the various web-sites selected by the end-user to be aggregated in a format suitable for delivery to the client. A link re-writing logic rewrites embedded in the content gathered during the scrapping procedure of the present invention in order to make the aggregated content appear stored in the wireless server. Content selection in the present invention is user defined, but content delivery is defined by the scrapping logic, which allows the user selected content to be delivered in a client aware manner based on the client type information.

### CROSS REFERENCE TO RELATED APPLICATION

This patent application is related to co-pending patent application Ser. No. ______, filed on ______, by Luu Tran et al., entitled “Client Aware Detection in a Wireless Portal System”, attorney docket No.: SUN-P6087, which is hereby incorporated herein by reference in its entirety.

### FIELD OF THE INVENTION

The present claimed invention relates generally to the field of wireless communication systems. More particularly, the present claimed invention relates to client aware content scrapping and aggregation in a client independent wireless environment.

### BACKGROUND ART

The Internet has become the dominant vehicle for data communications. And with the growth of Internet usage has come a corresponding growth in the usage of Internet devices, wireless devices and services.

The growing base of Internet users has become accustomed to readily accessing Internet-based services such e-mail, calendar or content at any time from any location. These services, however, have traditionally been accessible primarily through stationary PCs. However, demand is now building for easy access to these and other communication services for mobile devices.

As the demand for mobile and wireless devices increases, enterprises must rollout new communication capabilities beyond the reach of traditional wired devices, by extending the enterprise with extra-net applications, etc., to effectively and efficiently connect mobile employees with their home base. As the number of digital subscribers grows, traditional wireless providers must find applications suitable to the needs of these new mobile users.

However, service providers are not the only ones seeking applications to meet the growing service needs of wireless users. Traditional portal developers are also extending their traditional PC browser desk-top services to these new wireless markets.

With the growth of the wireless market comes a corresponding growth in wireless business opportunities, which in today's ever-growing markets means, there is a plethora of services available to customers of the enterprises that use these services. Many wireless service providers are now looking to add to basic core services by extending services such as e-mail, short messaging service notification, and other links to Internet Protocol (IP) based applications to drive additional business and revenues.

As the wireless market grows and Internet access becomes more mainstream and begins to move to new devices, wireless service providers are looking to develop highly leveraged Internet Protocol based applications on top of existing network infrastructure. To meet the growing demand for wireless client devices, enterprises need to provide access to any type of service from any type of device from anywhere and to provide content suitable for these devices without incurring substantial cost overhead.

The growth in wireless devices also means that traditional computer users who used to be tied to their desktop computers may now be mobile and would require remote access to network applications and services such as email. The mobility of wireless users presents a host of challenges to service providers who may have to provide traditional service to these new wireless devices. One such service is provided by Sun Microsystems, Inc., through its iPlanet™ platform to allow service providers to grow their services from basic traditional services such as voice to leading edge wireless applications with carrier-grade reliability and performance.

In addition to the traditional network applications that these new wireless users seek the growth of the Internet and the introduction of new Internet enabled wireless devices have led to the explosive use of community-based web site or portals. This growth in portals has created a need for wireless environments to provide portal support to handle the collection of data related to different topics such as news, stock quotes, applications and services required by wireless device users.

FIG. 1 depicts a prior art wireless client dependent based environment solution to handle similarly configured wireless client running similar applications or portals. The environment depicted in FIG. 1 includes wireless devices such as a Wireless Applications Protocol (WAP) phone 101, a wireless PC 102, a refrigerator 103, etc. In general, the wireless environment depicted in FIG. 1 is categorized into the network (Internet 104), Clients (e.g. mobile phone 101, PCs 102 and household appliances 103) and resources (e.g., web-sites 105, portals 106 and other applications 107).

For most of the wireless clients connected to the Internet 104, portals 106 offer the client the starting point of experiencing the Internet 104. Portals 106 are typically community-based web-sites that securely hold a collection of data related to different topics, including such applications as news, stock quotes, etc. For example, a wireless client connecting to the Internet will first login to a web portal site (e.g., yahoo) and from there browse through various sites to search for a host of different services.

The portals typically reside in a portal server which bundles an aggregation of services provided by an Internet service provider and provide these services to wireless clients. A wireless portal server such as that developed by Sun Microsystems, Inc. provides such portal access to wireless application resources residing on resource servers A 108, B 109 and C 110.

The prior art wireless server depicted in FIG. 1 primarily supports the two major types of browsers known by most Internet users. These include the Microsoft Internet Browser and the Netscape Communicator Browser. These browsers are both HyperText Markup Language (HTML) based and suitable for some wireless devices, especially devices with large display screens. However, as wireless display screens get smaller in size, traditional HTML browsers are no longer suitable for transmitting content to these wireless devices.

To ensure suitable content delivery, wireless device and wireless software providers have developed a myriad of micro-browsers that appropriately adapt to these wireless devices with different display screen requirements in order to take advantage of the numerous contents on the Internet. The availability of these new micro-browsers means that service providers do not have to create different sets of content for different wireless devices even if the devices are dissimilar.

In the prior art system depicted in FIG. 1, content delivery is primary performed in HTML over such protocols as TCP and HTTP. This content is suitable for devices with wider screen display such as desktop or wireless PCs. Due to the large screen displays these prior art systems have, a resource server does not have to format content prior to delivery to these devices.

Thus, for the prior art server to support the various types of wireless client that service provider's support, a system's administrator has to painstakingly manually add client specific content to support each wireless client if and when the client attempts to access the server.

Content delivery by a service provider in the prior art system depicted in FIG. 1 is typically conducted by syndication. In this process, the service provider is able to gather content from multiple web-sites and aggregate (syndicate) the content to give the appearance that the service provider is the original source of the syndicated content. In this prior art content syndication method, the syndicated content is only suitable for wireless devices of the same or similar configuration.

Content scrapping from multiple sites look fine in most prior art cases except for devices that require strictly formatted content, e.g., wireless phones or hand-held devices. For HTML devices, the service provider can strip off some well known markup tags and modify links embedded in the Uniform Resource locator (URL) to reference URL resources through the service provider's system. However, as wireless devices proliferate and the configurations of these devices differ, the prior art method of syndicating content scrapped from multiple web-sites, while giving the appearance that the content is emanating from a single site, for presentation to these devices is unable to provide suitable formatted content for such devices. This is because many of the sites being scrapped do not have the ability or capability to provide content in a client aware manner, i.e., based on specific client type information.

Another drawback of the prior art scrapping system is that content scrapping is typically performed only for desktop computer systems. In these systems, the URL scrapper retrieves pages specified by the URL and inserts the pages into a table cell defined for the content scrapped. The retrieved pages are typically HTML pages which contain entire pages including corresponding <HTML><HTML> tags. In these instances, the desktop browser either ignores the tag syntax or is able to understand the syntax. However, when a page is retrieved based on any wireless markup language, duplication of the wireless tags causes a syntax error and the page is unable to be displayed.

As the number of models of wireless clients increase, having restricted content and very limited information about client characteristics impairs the ability of service providers to take advantage of new wireless technologies and provide efficient and cost effective services. This also impairs the ability of the wireless client to enjoy the full richness and look and feel of user interfaces provided by the server.

### SUMMARY OF INVENTION

Accordingly, to take advantage of the myriad of wireless applications and the numerous wireless clients being developed, a wireless server with extensibility capabilities to allow content delivery to wireless clients to be configured based on pre-defined client type and formatted by the wireless server is needed. A need exists for “out-of-the-box” wireless client aware system solutions to allow technically unsophisticated end-users to connect to the wireless environment without unduly tasking the end-user's technical abilities. A need further exists for an improved and less costly device independent system, which improves efficiency and provides content to various wireless clients of different configurations without losing the embedded features designed for these devices.

A wireless portal system has a wireless server with a client aware content scrapping and aggregation method and system. The client aware content scrapping and aggregation system includes logic for identifying client wireless devices connecting to the wireless by using particular characteristics of the client in presenting content selected in response to connection requests from the client to the server. In one embodiment of the invention, the client aware content scrapping system receives an indication of a client type and uses this information to automatically search for content from a variety of web-sites on the Internet and formats content selected by the end-user for delivery to the client. The scrapping logic further allows content gathered from the various web-sites selected by the end-user to be aggregated in a format suitable for delivery to the client. A link re-writing logic rewrites embedded in the content gathered during the scrapping procedure of the present invention in order to make the aggregated content appear stored in the wireless server. Content selection in the present invention is user defined, but content delivery is defined by the scrapping logic, which allows the user selected content to be delivered in a client aware manner based on the client type information.

Embodiments of the present invention are directed to a system and a method for wireless client aware content selection and presentation in a wireless network environment. In general, embodiments of the present invention vary the degree of providing content gathered from a variety of web-sites to a wireless client connecting to the wireless environment. The present invention implements client aware content aggregation to retrieve content based on detailed client type information. In other words, the invention provides client specific content aggregation of content scrapped from various web-sites and presented in a wireless network environment. The invention is suitably adapted to function in a wireless portal environment.

Embodiments of the invention include an integrated Internet content management solution designed to improve the availability of Internet content gathered from a variety of web-sites for delivery to a variety of differently configured wireless clients based on client type information specified by the client to a wireless server. The present invention allows for the intelligent aggregation of Internet content gathered from dissimilar web-sites or geographically dispersed content into a coherently and cohesively formatted content suitable for delivery to the requesting client.

Embodiments of the invention include a content scrapper to dynamically search back-end services in the wireless environment for end-user specified content for delivery to the client's home page in the wireless server. The content scrapper further creates a portal session based on the client type information provided by a client connecting to the wireless network. Information created in the session is used to retrieve client specific content from back-end services connected to the wireless server.

In one embodiment of the present invention, the content scrapper includes provider logic which generates Wireless Markup Language (WML) decks and other wireless adaptable language decks based on the method invoked to provide content to a requesting client. The provider logic generates the correct WML that is appropriate for the type of Wireless Application Protocol device requesting information based on pre-existing knowledge of the supported device type.

In another embodiment of the present invention, the content scrapper logic is responsible for encapsulating or formatting the back-end server content into appropriate markup language for delivery to the wireless clients. Service applications in the wireless server of the present invention know which scrapping method to invoke based on information embedded in the User Agent contained in the HTPP header from a client request.

Embodiments of the present invention further include client aware content source logic that creates a list of the Uniform Resource Locators used by the scrapping logic to gather content specified by the end-user. In other words, the client aware source logic acts as an index to the URLs that points to the web-sites where content is scrapped. Content scrapping is based on the type of client device, the type of services offered by the service provider and whether the client is authorized to scrap the content. An Application Programmable Interface can be used to collect extensible data sets that include custom client parameters for automatically identifying content of a particular client or class of clients.

Embodiments of the present invention further include content aggregation logic that is capable of dynamically aggregating content scrapped from multiple sources into cohesive content for delivery to clients connecting to the wireless server. In the present invention, the service provider can remotely control the content aggregation logic in order to dynamically make content available to the client depending on the client type information stored in the wireless server.

In one embodiment, automatic client detection logic identifies the type or class of the client and stores this information into a client session data structure. The client session information can then be used by the content selection system to automatically access the most pertinent content data for the client using an intelligent file retrieval system. Client identification or class information can be used in automatically determining whether content desired by the client is available, selectable and presentable to the client. The content selection system receives an indication of a client type and uses this information to automatically construct content available for the client. The wireless server also modifies the links that are in the scrapped content so that the client must go through the wireless server to get to the link.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

Prior Art FIG. 1 is a block diagram of a conventional device dependent wireless system;

FIG. 2 is a block diagram of an implementation of a device independent wireless system of an embodiment of the present invention;

FIG. 3 is a block diagram of an exemplary internal architecture of the wireless server of FIG. 2;

FIG. 4 is a block diagram of an embodiment of the wireless data scrapping environment of the present invention;

FIG. 5 is a block diagram of an embodiment of an internal architecture of a wireless Uniform Resource Locator (URL) of an embodiment of the present invention; and

FIG. 6 is a flow diagram of an exemplary implementation of the scrapping procedure of one embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The invention is directed to a system, an architecture, subsystem and method to manage a wireless clients content selection in a client independent wireless environment in a way superior to the prior art. In accordance with an aspect of the invention, a wireless server provides wireless client aware content selection and presentation which enables client characteristics of devices to be used in determining the type of content to present by the wireless server.

In the following detailed description of the present invention, a system and method for a wireless Internet protocol based communication system are described. Numerous specific details are not set forth in order to provide a thorough understanding of the present invention. However, it will be recognized by one skilled in the art that the present invention may be practiced without these specific details or with equivalents thereof.

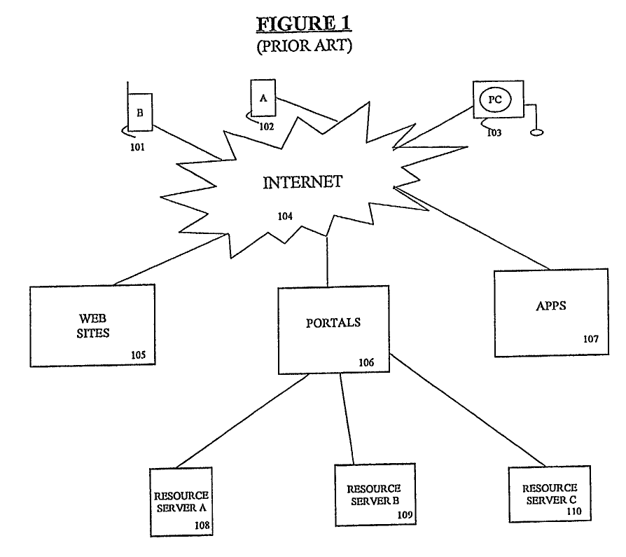

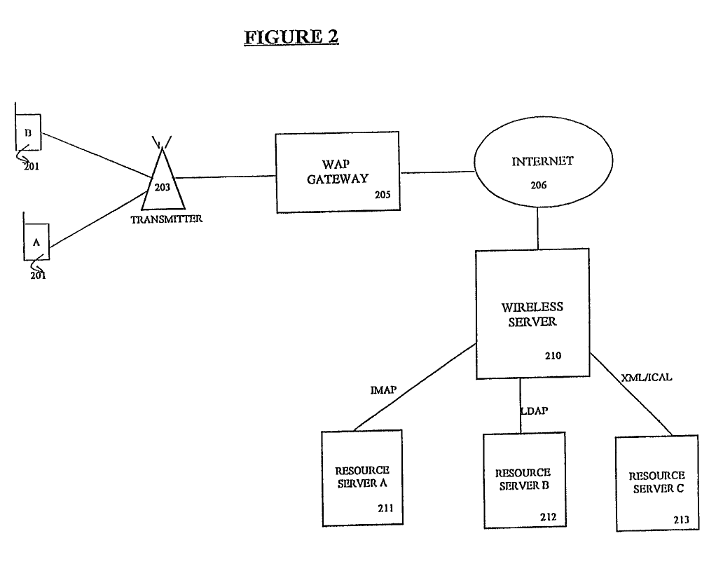

Generally, an aspect of the invention encompasses providing an integrated wireless Internet server which provides a wide range of voice, data, video and other services to wireless clients which may connect to the wireless environment to be serviced alongside predefined wireless clients. The invention can be more fully described with reference to FIGS. 2 through 6.

FIG. 2 depicts a wireless device independent based environment of the present invention. The wireless environment depicted in FIG. 2 comprises a wireless application protocol (WAP) based phone 201, a WAP transmission infrastructure 202, a WAP gateway 205, the Internet 206 and a wireless server 210. The WAP gateway 205 typically resides on the Local area network (LAN) within a telecom carrier premise. It is generally not a part of the wireless server 210. The WAP gateway 205 is responsible for converting the Wireless Markup Language (WML)/Hyper Text Transport Protocol (HTTP) content and protocol into a binary compressed, encoded, encrypted version of WML over WAP.

Conversely, the WAP gateway 205 also performs the translation of WAP commands into HTTP requests that can be sent over the public Internet 206. For example, in a GSM network, when a phone transmission is received by the mobile switching center, the gateway 205 distinguishes the transmission as a packet data and sends it to the proper channel to be processed. The WAP gateway 205 decompresses and decrypts the packets, as well as several other functions and formats the data into an HTTP request that is sent to the wireless server 210. The WAP gateway 205 can also store user's bookmarks, two of which could point to the wireless server's messaging and other resource services. The wireless server 210 communicates Wireless Markup Language (WML) over HTTP on the front-end and communicates in native protocol of the target server on the back-end.

The wireless server communicates to these back-end resource servers using the backend server's native protocol. For example, the wireless server may communicate to resource server A 211 which may be a messaging server using IMAP. Lightweight Directory Access Protocol (LDAP) is used for all communications to and from the resource server B 212. And an Extensible Markup Language (XML) protocol may be used to communicate with resource server C 213.

Although the wireless server depicted in FIG. 2 is capable of communicating in these native protocols shown in FIG. 2, the wireless server's 210 protocol handling capability can be extended to support a variety of other protocols. The wireless server implements the WML interface and generates the corresponding WML content based on what it receives from the back-end server. The wireless server 210 also processes incoming HTTP requests in which a wireless device sending data or a request to the back-end servers. The wireless environment depicted in FIG. 2 typically supports wireless devices of dissimilar configuration and is thus device independent.

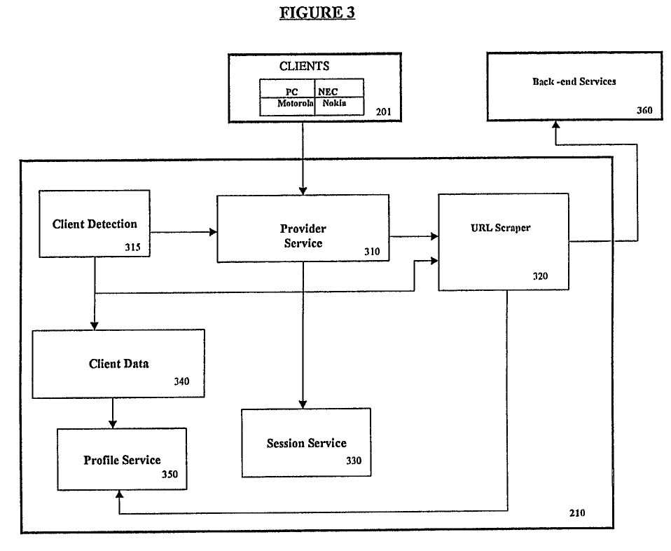

FIG. 3 is a block diagram illustration of one embodiment of the wireless server of the present invention. Wireless Server 210 (WS) comprises, Content Provider Service module 310, Client Detection module 315, Uniform Resource Locator (URL) 320, Session Service (SS) module 330, Client Data module 340 and Profile Service (PS) module 350. The server 210 also couples to back-end service 360 to retrieve content requested by the wireless clients connecting to the server 210.

The wireless server depicted in FIG. 3 is a flexible, scalable, extensible and capable of supporting a rich evolving range of networks such as Global System for Mobile communication (GSM) Networks, Code Division Multiple Access (CDMA) Networks, Time Division Multiple Access (TDMA) Networks, Third Generation (3G) Networks and others.

The architecture of the server is also capable of handling a variety of wireless environments and markup languages such as the wireless markup language (WML), the handheld device markup language (HDML) and the hypertext markup language (HTML). The server is capable of providing support for multiple devices and is easily adaptable and extensible to additional devices and markup languages.

Still referring to FIG. 3, Provider Service module 310 is coupled to provide a client with the ability to select and present content to a user's homepage and navigation links to other providers in the server 210. An example of how an end-user can select content using the Provider Service 310 is described in co-pending U.S. patent application titled “Client Aware Content Selection and Retrieval in a Wireless Portal System, file on even date, Ser. No.: ______, assigned to the assignee of the present invention and hereby incorporated by reference herein.

URL scrapper 320 is coupled to the Provider Service 310 and the Client Detection 315 to store URLs for all the defined client types of clients supported by the wireless server 210 in Profile Service 340. URL scrapper 320 parses incoming client requests to determine and extract client type information in order to deliver the corresponding scrapped content to the client in a format that is customized for the client. In the present invention, the profile attributes and the URLs for each supported client type is configured by the systems administrator of the wireless server 210 and not by the end user. Client type information may be dynamically added during system run-time to allow newly authorized client types to connect to the server 210. URL Scrapper 320 enables the service provider to syndicate multiple content scrapped from a variety of web-sites into a single source for presentation to the wireless clients connecting to server 210. In the present invention, content is scrapped from the variety of web-sites in a client aware manner. In other words, content is scrapped in response to pertinent unique client information provided by the client.

In the scrapping procedure of the present invention, wireless server 210 acts as an intermediary server for URL Scrapper 320 requests to the different web-sites from which content is gathered. Client requests to URL 320 are handled by the wireless server 210 which communicates with the back-end resource service 360 to gather content from the various resources stored in the back-end resource service 360. Requests to the back-end service 360 are processed based on the client type information provided by the Client Detection service 315 of the wireless server 210. The Function of Client Detection Module 315 is described in the co-pending US Patent Application entitled “CLIENT AWARE DETECTION IN A WIRELESS PORTAL SYSTEM”, filed on even date, Ser. No.: ______, assigned to the assignee of the present invention and hereby incorporated herein by reference.

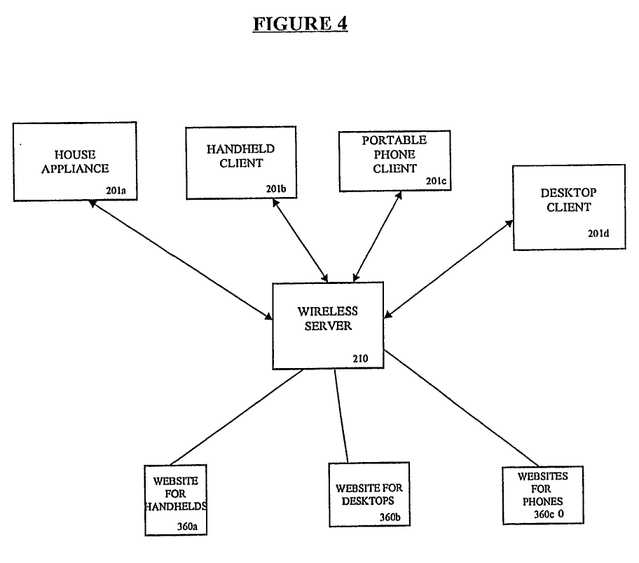

In the scrapping environment of the present invention, when the URL Scrapper 320 has to provide content to multiple clients with different configurations, for example as depicted in FIG. 4, a wireless phone 201c, a hand-held device 201b, a wireless PC 201d or a house-hold appliance 201a, etc., the wireless server 210 acts as a switch by routing requests from the various clients to the appropriate back-end resource service, e.g., web-sites 360a-360c depending on the client type. Therefore, the wireless server 210, using the URL Scrapper 320, could act as a proxy server if the scrapped web-site does not have client awareness capabilities.

URL Scrapper 320 uses the Client Data 340 to access a file path property in the server 210 to retrieve appropriate device specific templates. In the present invention, client data objects are extensible to allow additional properties to be added as needed for use by URL Scrapper 320. The present invention provides methods to display specific content in the form of channels. On an HTML device, these channels appear as table cells and on WML devices the channels appear as links to WML cards containing the contents of the channel.

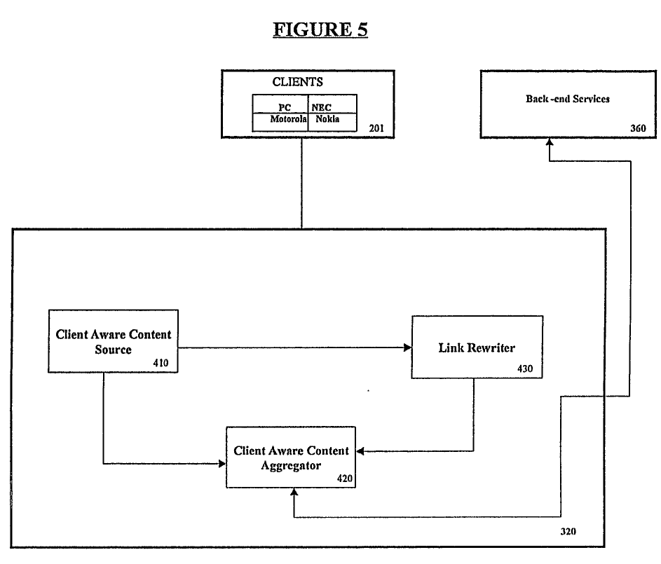

Reference is now made to FIG. 5 that is a block diagram illustration of one embodiment of the URL Scrapper 320 of the present invention. As depicted in FIG. 4, URL Scrapper 320 comprises a client aware content source 410, client aware content aggregator 420 and client aware link rewriter 430.

Client aware content source 410 is coupled the content aggregator 420 to receive clients request to URL Scrapper 320 and search web-sites for content specified in the User Agent in the client's request header from target back-end resource services. The content located by content source 410 is then passed to content aggregator 420 for processing.

Content Aggregator 420 is coupled to content source 410 to parse and aggregate content scrapped from the various web-sites 360a-360c, as depicted in Figure, identified by content source 410. In the present invention, Content Aggregator 420 combines the various content scrapped from the numerous web-sites into a coherent and cohesive client aware content suitable for delivery by the wireless server 210 to clients 201a-201d connecting to the server 210.

In processing the content combination, Content Aggregator 420 uses Content Link Rewriter 430 to rewrite links embedded in the scrapped content to make the client aware content that is ultimately provided to the wireless client appear to originate from the wireless server 210. All links therefore go through the wireless server 210. By rewriting links, the Content Link Rewriter 430 ensures that the client does not have links embedded in the content provided by the server 210. Content Link rewriter 430 also enables the service provider to customize content scrapped from other sites to make the content presentable to its clients. For example, the service provider may remove advertisements from content scrapped from a web-site when the content is presented to the service provider's clients.

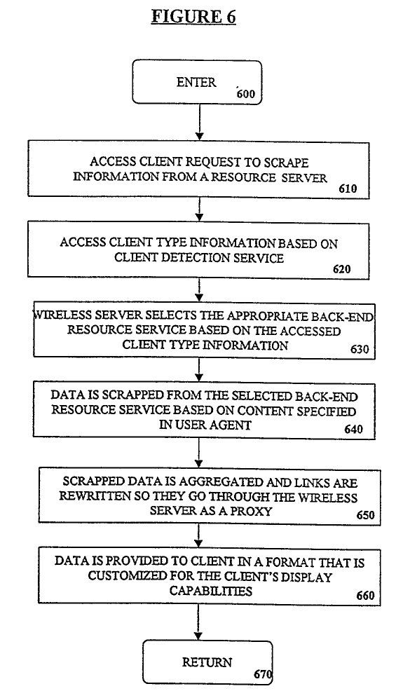

Reference is now made to FIG. 6 which is an exemplary flow diagram of one embodiment of the scrapping procedure of the present invention. The scrapping procedures commences at step 600 when the wireless client 201a-201d initiates a content request to server 210. At step 610, the server access the client's request to scrape information from a resource server 360a-360c. The wireless server 210 access the client's request based on the client type information stored in the client detection service 315 at step 620.

At step 630, the URL Scrapper 320 selects the appropriate back-end resource service based on the accessed client type information. The URL Scrapper 320 then uses the client type information to scrap data from the selected back-end resource service based on the content specified in the User Agent presented in the client's request header at step 640.

At step 650, the URL Scrapper 320 aggregates the scrapped data and rewrites links contained in the scrapped data so that the links go through the wireless server 210 as a proxy to the back-end resource server 108-110. After rewriting the links contained in the scrapped data, the URL Scrapper 320 then provides the scrapped data in a format that is customized for the client's display capabilities at step 660. The URL Scrapper 320 then ends the scrapping process at step 670.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A wireless server system comprising:
an applications content locator module for locating wireless applications content over multiple web-sites pertinent to a type of wireless client; and
an applications content aggregation service, in response to receiving a particular client type associated with a particular wireless client, for dynamically presenting authorized aggregated content in a format suitable to said wireless client based on said particular client type, and
wherein said application content aggregation service is also for formatting selected content to said particular wireless client for presentation thereto.

2. The wireless server system of claim 1, further comprising an applications content source module coupled to said content locator module for determining the source of content requested by said particular wireless.

3. The wireless server system of claim 1, further comprising an automatic client detection service for automatically detecting and providing client type information of said particular wireless client.

4. The wireless server system of claim 3, wherein said particular client provides a service request to determine the type of content to be delivered to said particular client.

5. The wireless server system of claim 1, further comprising stored information pre-defining client type information of clients supported by said wireless server system.

6. The wireless server system of claim 1, further comprising content link rewriting logic coupled to the content locator module for rewriting links embedded in said content retrieved from said web-sites for directing access from said links to go through said wireless server system as an intermediary.

7. The wireless server system of claim 6, wherein said wireless server system with respect to said links acts as a proxy server between wireless client connecting to said wireless server system and back-end resource servers in which said content reside.

8. The wireless server system of claim 7, wherein said particular client is a hand-held device.

9. The wireless server system of claim 8, wherein said particular client is a wireless phone.

10. The wireless server system of claim 9, wherein said particular client is a wireless personal computer system.

11. A client aware applications content location and retrieval system in a wireless network, comprising:
a wireless server;
a plurality of classes of wireless clients, each of said classes of wireless clients comprising unique identification parameters; and
a client aware content location service for providing content location and retrieval procedures in response to client type identifications of content access requests from said wireless clients.

12. The client aware content location and retrieval system of claim 11, further comprising a client aware content aggregation module coupled to said content locator service for aggregating client aware content gathered from a plurality of web-sites over the Internet for presentation in a format suitable for said wireless client.

13. The client aware content location and retrieval system of claim 11, wherein the content location service includes a client aware content aggregation logic for formatting content specific to a wireless client type.

14. The client aware content location and retrieval system of claim 12, wherein said content location service further comprises a client aware content source module for identifying content location over said plurality of web-sites in response to the client type information provided by said plurality of classes of wireless clients.

15. The client aware content location and retrieval system of claim 11, further comprising a content link re-writing module coupled to said content locator service for rewriting links indexing to contents scrapped from variety of web-sites.

16. The client aware content location and retrieval system of claim 15, wherein said content is provided in response to said particular client provided said content is authorized to said particular client and is aggregated for said particular client.

17. A wireless server, comprising:
a client aware content locator service for providing information gathered from a plurality of resource servers in a coherent and cohesive format to a client in a client aware fashion based for each respective client type; and
a profile service logic for storing client profile information for said clients accessing said wireless server.

18. The wireless server of claim 17, wherein said client aware content locator comprises a client aware content source service for identifying the source of said content in said plurality of locations for a particular client and for presenting content suitably formatted for said client.

19. The wireless server of claim 18, wherein said content locator further comprises a client aware content aggregator coupled to said client aware content source service to aggregate content gathered from said plurality of location into a consolidated formatted content suitable for presentation to said particular client in a client aware manner.

20. The wireless server of claim 18, wherein said content locator further comprises a content rewriting service for rewriting links indexing the source of content scrapped from said plurality of locations in order for the scrapped content to appear forcing the wireless to act as an intermediary to said particular client.

21. The wireless server of claim 20, wherein said plurality of content locations are web-sites coupled to communicate on the Internet.

22. The wireless server of claim 20, wherein said aggregated content comprises a wireless handheld markup language.

23. The wireless server of claim 22, wherein said client type information is extensible to dynamically include run-tine content parameters unique to said client.

24. The wireless server of claim 23, wherein said wireless server further comprises a content provider service for selecting content pertinent and uniquely identifiable to said client.

25. The wireless server of claim 24, wherein said provider service further comprise availability logic for determining whether content selected by said client is available for presentation to said client.
